(19) United States
(12) Patent Application Publication
(10) Pub. No.: US 2018/0191170 A1
(43) Pub. Date: Jul. 5, 2018

(54) CHARGING SYSTEM

(71) Applicant: Chicony Power Technology Co., Ltd., New Taipei City (TW)

(72) Inventors: Shuo-Kuo HUANG, New Taipei City (TW); Qi SHEN, New Taipei City (TW); Yuji GU, New Taipei City (TW)

(21) Appl. No.: 15/431,191

(22) Filed: Feb. 13, 2017

(30) Foreign Application Priority Data
Dec. 30, 2016 (CN) 201611258757.6

(51) Int. Cl. H02J 7/00

(52) U.S. Cl. CPC H02J 7/007; H02J 2007/005; H02J 7/0047

(57) ABSTRACT

A charging system for charging a battery is disclosed. The charging system includes a first light emitting diode (LED), a second LED, a power conversion module, and a charge control module. The charge-controlling module includes a controlling unit and a comparator electrically connected to the power conversion module. When a voltage of the battery is lower than or equal to a critical voltage, the controlling unit illuminates the first LED. When the voltage of the battery is greater than the critical voltage, the controlling unit illuminates the second LED. When the voltage of the battery is lower than or equal to a regulation voltage, the comparator makes the power conversion module to charge the battery with a constant current, and when the voltage of the battery is greater than the regelation voltage, the controlling unit makes the power conversion module to charge the battery with a constant voltage.

### BACKGROUND

### Technical Field

The present disclosure relates to a charging system. More particularly, the present disclosure relates to a charging system providing an indication whether the battery is fully charged or not.

### Description of Related Art

Generally, it is very desirable to be able to know when the battery being charged has reached a fully charged state. For example, the indicator for illuminating red light indicates that a charging procedure is performing, and the indicator for illuminating green light indicates that the battery is almost fully charged. In addition, the indicators for illuminating red light and green light are turned off while no battery is connected to the charger.

However, the tradition charger including the indicators for illuminating red light and green light mainly has two drivers for respectively driving the indicators to illuminate, thus the circuits of the charger including the drivers is complex and bulky.

### SUMMARY

The present disclosure is directed to invention a system for charging battery. Generally, in one aspect, a charging system, configured to charge a battery, includes a first light emitting diode (LED), a second LED, a power conversion module, and a charge-controlling module; the power conversion module is electrically connected to the first LED and the second LED. The charge-controlling module includes a controlling unit, a comparator, and a transistor; the comparator is electrically connected to the power conversion module, and the transistor is electrically connected to the controlling unit, the first LED, and the second LED. When a voltage of the battery is lower than or equal to a critical voltage, the controlling unit outputs a low level signal to the transistor to illuminate the first LED and turn the second LED off, and when the voltage of the battery is greater than the critical voltage, the controlling unit outputs a high level signal to the transistor to turn the first LED off and illuminate the second LED. When the voltage of the battery is lower than or equal to a regulation voltage, the comparator outputs a first signal to drive the power conversion module to charge the battery with a constant current, and when the voltage of the battery is greater than the regulation voltage, the controlling unit provides a second signal to drive the power conversion module to charge the battery with a constant voltage, the regulation voltage is smaller than the critical voltage.

In one embodiment of the present disclosure, the controlling unit may include a first operational amplifier (OPA) and a Zener diode; the first OPA includes two inputs and an output, wherein one of the inputs is electrically connected to a first node for receiving a first voltage, the other input is electrically connected to a second node for receiving a second voltage, and the output is connected to the power conversion module. The Zener diode is electrically connected to the second node. The Zener diode provides voltage stabilizing function when the voltage of the battery is greater than the regulation voltage, and the first OPA generates the second signal when the voltage of the battery is greater than regulation voltage for driving the power conversion module to charge the battery with the constant voltage.

In one embodiment of the present disclosure, the charge-controlling module may further include a first diode arranged between the power conversion module and the output of the first OPA and electrically connected to the power conversion module and the output the first OPA, the first diode conducts when the second signal is sent from the output of the first OPA.

In one embodiment of the present disclosure, the charge-controlling module may further include a first voltage-dividing resistor and a second voltage-dividing resistor; the first voltage-dividing resistor is arranged between the power conversion module and the first OPA and electrically connected to the power conversion module and the first OPA. The second voltage-dividing resistor is electrically connected to the first voltage-dividing resistor in series; the first voltage-dividing resistor and the second voltage-dividing resistor receive a charging voltage provided by the power conversion module and then generate the first voltage.

In one embodiment of the present disclosure, the charge-controlling module may further include a sense resistor electrically connected to the battery and used for sensing a current flowing through the battery indicating the voltage of the battery. The controlling unit further comprises a second OPA comprising two inputs and an output, one of the inputs is electrically connected to the power conversion module, the other input is electrically connected to the sense resistor, and the output is connected to the transistor, the second OPA outputs the low level signal when the voltage of the battery is lower than or equal to the critical voltage to illuminate the first LED, and the second OPA outputs the high level signal when the voltage of the battery is greater than the critical voltage to illuminate the second LED.

In one embodiment of the present disclosure, the charge-controlling module may further include a first capacitor placed between the outputs of the first OPA and second OPA and electrically connected thereto, the first capacitor is charged when the voltage of the battery is lower than or equal to the critical voltage; when the voltage of the battery is greater than the critical voltage, the voltage charged in the first capacitor is applied to the output of the first OPA for increasing the level of signal sent from the output of the first OPA.

In one embodiment of the present disclosure, the charging system may further include a second diode arranged between the power conversion module and an output of the comparator and electrically connected thereto, the second diode conducts when the first signal is sent from the output of the comparator, and the power conversion module is driven to charge the battery with the constant current.

In one embodiment of the present disclosure, the charge-controlling module may further include a third voltage-dividing resistor, a fourth voltage-dividing resistor, and a fifth voltage-dividing resistor; the fourth voltage-dividing resistor is electrically connected to the third voltage-dividing resistor in series, and the fifth voltage-dividing resistor is arranged between the third voltage-dividing resistor and the power conversion module and electrically connected to the third voltage-dividing resistor and the power conversion module, the third voltage-dividing resistor, the fourth voltage-dividing resistor, and the fifth voltage-dividing resistor receive the charging voltage provided by the power conversion module and then generate the second voltage and a compared voltage, wherein the compared voltage is applied to an input of the comparator, and the other input of the comparator is electrically connected to the sense resistor.

In one embodiment of the present disclosure, the charge-controlling module may further include a second capacitor arranged between an output of the comparator and the input of the first OPA where the first node is connected and electrically connected thereto for absorbing transition noise of the comparator and power noise.

In one embodiment of the present disclosure, the transistor may be an NMOS transistor. The charge-controlling module of the present disclosure may drive the first LED to illuminate red light or drive the second LED to illuminate green light for indicating charge state of the battery and charge the battery with a low current (when operated in the trickle charge phase), the constant current or the constant voltage based on the voltage of the battery, thus functions of protection and lifetime extension of the battery are achieved. The charging system of the present disclosure may further include advantage of small volume.

### BRIEF DESCRIPTION OF DRAWING

The present disclosure can be more fully understood by reading the following detailed description of the embodiment, with reference made to the accompanying drawings as follows:

FIG. 1 is a circuit diagram of a charging system of the present disclosure;

FIG. 2A is a component diagram of the LED;

FIG. 2B shows a typical relationship of forward current to forward bias in the LED;

FIG. 3 is a circuit diagram of a power conversion module according to the present disclosure;

FIG. 4 shows typical relationships of forward current to forward bias in the first LED and the second LED;

FIG. 5 is a schematic charging diagram illustrating a charging current and a charging voltage of a battery for the charging system; and

FIG. 6 is a waveform diagram of signal sent form the output of the first OPA.

### DETAILED DESCRIPTION

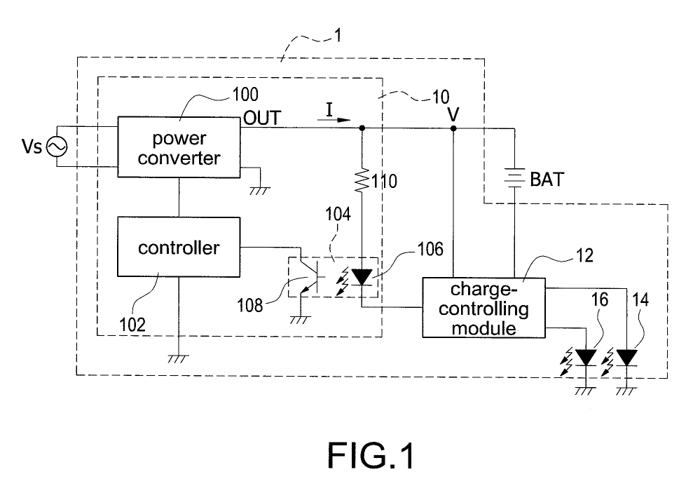

Reference is made to FIG. 1, which is a circuit diagram of the charging system according to the present disclosure. In FIG. 1, the charging system 1 is arranged between a power supply terminal Vs and a battery BAT and is connected to the power supply terminal Vs and the battery BAT. The charging system 1 is configured to generate a charging current I for charging the battery BAT. The power supply terminal Vs may be mains, power adapters or other electronic device for outputting electricity. Herein, the power supply terminal Vs is an alternative current (AC) power source.

The charging system includes a power conversion module 10, a charge-controlling module 12, a first light emitting diode (LED) 14 and a second LED 16. A power output OUT of the power conversion module 10 is connected to the positive terminal of the battery BAT. The power conversion module 10 includes a power converter 100, a controller 102, and an optical coupler 104; the power converter is connected to the power supply terminal Vs and configured to convert an AC electricity supplied by the power supply terminal Vs into a direct current (DC) electricity for charging the battery BAT. The controller 102 is arranged between the power converter 100 and the optical coupler 104 and electrically connected thereto; the controller 102 is, for example, a pulse width modulator and configured to modulate a pulse width modulating (PWM) signal with a particular duty cycle in accordance with the output of the optical coupler 104. The PWM signal with the particular duty cycle is fed to the power converter 100 for regulating a charging voltage V and a charging current I outputted therefrom.

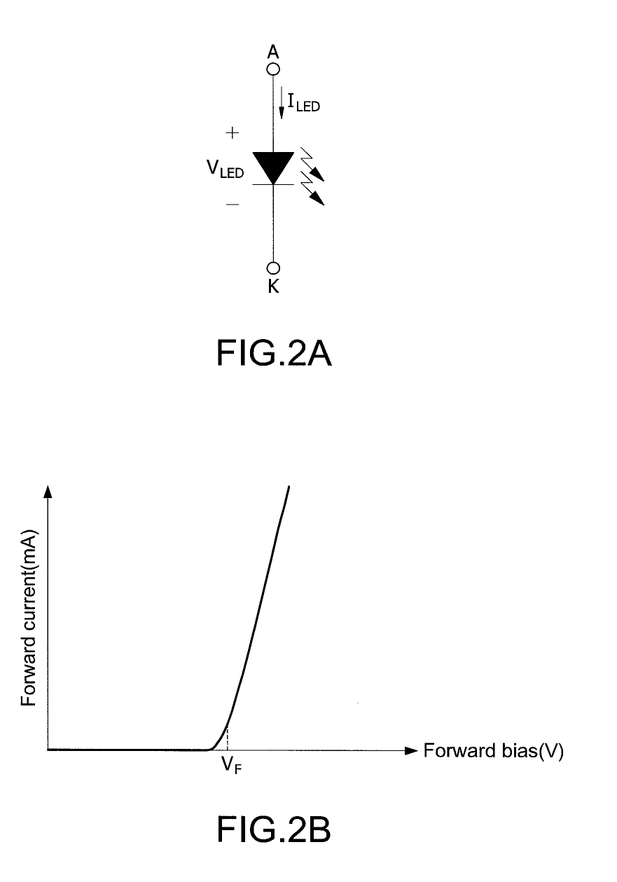

The optical coupler 104 includes a light emitter 106 and a light receiver 108 in optical communication with the light emitter 106; the light emitter 106 may be an LED. Reference is made to FIG. 2A, the LED has an anode A and a cathode K, when a voltage V_{LED} across the LED is smaller than or equal to a forward bias V_{F}, the LED remains off so that no current flow through the LED; on the contrary, when the voltage V_{LED} across the LED is larger than the forward bias V_{F}, the LED is on so that a forward current flowing through the anode A to the cathode K. As can be seen in FIG. 2B, the forward current is increased while the voltage V_{LED} across the LED increases.

With referring again to FIG. 1, the anode of the light emitter 106 is connected to the power output OUT via a current-limiting resistor 110, and the cathode thereof is electrically connected to the charge-controlling module 12. The current-limiting resistor 110 is configured to limit the current that flows through the light emitter 106 for protecting the light emitter 106. The light receiver 108 may be a phototransistor. The light receiver 108 is optically coupled to the light emitter 106 and (its collector) is electrically connected to the controller 102. The light emitter 106 is used for converting an input electrical signal into optical radiation, and the light receiver 108 is used for reconverting the optical radiation to an electrical signal; in other words, the light emitter 106 is not directly electrically connected to the light receiver 108, which allows a one-way transmission of optical radiation in the charging system 1, so that circuits directly connected to the light emitter 106 and the light receiver 108 are electrically isolated from each other, and a capability of anti-interference is provided.

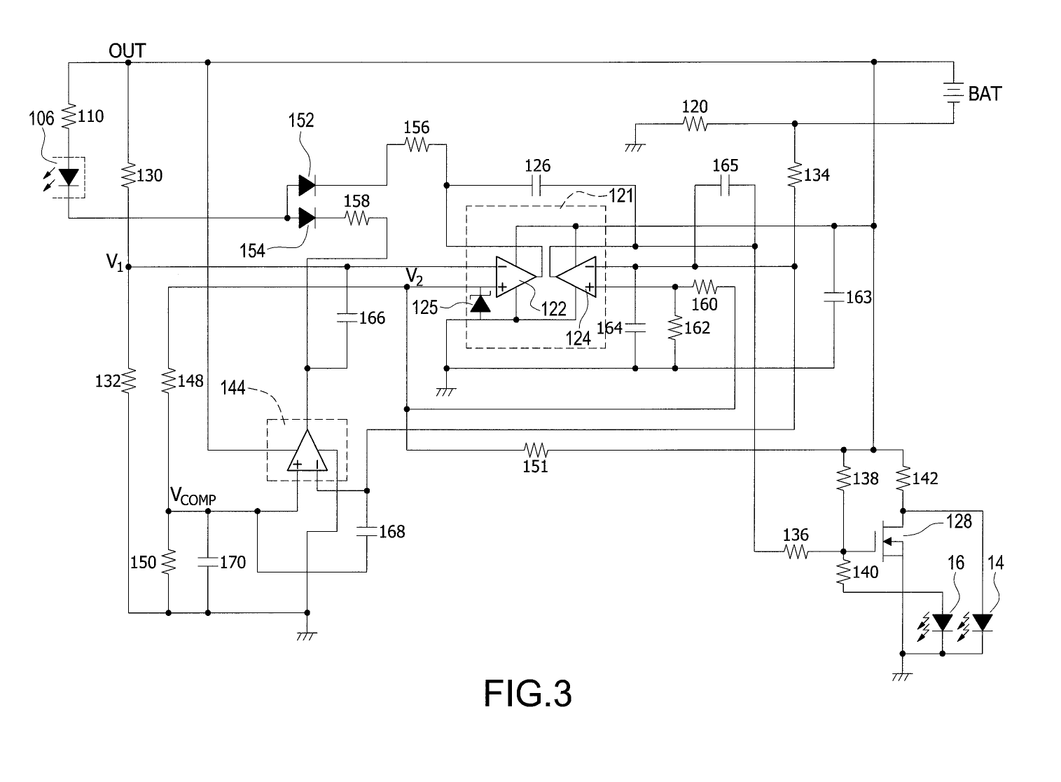

Reference is made to FIG. 3, which is a circuit diagram of a charge-controlling module according to the present disclosure. For purpose of convenience of discussion, FIG. 3 further illustrates the battery BAT, the light emitter 106, and the current-limiting resistor 110. The charge-controlling module 12 includes a sense resistor 120, a first operational amplifier (OPA) 122, a second OPA 124, a first capacitor 126, and a transistor 128; the sense resistor 120 may be arranged between the battery BAT and ground and connected thereto. The sense resistor 120 can have a resistance suitable for generating a sensing voltage indicating the amount of charging current I (i.e., the current flowing through the battery BAT) generated by the power converter 100, so that voltage of the battery is measured. In FIG. 3, the first OPA 122 and the second OPA 124 collectively constitute a controlling unit 121. Additionally, the charge-controlling module 12 may further includes a Zener diode 125; the cathode of the Zener diode 125 is connected to a non-inverting input of the first OPA 122, and the anode thereof is connected to ground.

The first OPA 122 includes an inverting input, the non-inverting input, and an output; the inverting input of the first OPA is electrically connected to a first node with a first voltage V₁. In FIG. 3, the first-voltage-dividing resistor 130 and the second voltage-dividing resistor 132 collectively constitute a voltage-dividing circuit; the voltage-dividing circuit constituted by the first voltage-dividing resistor 130 and the second voltage-dividing resistor 132 receives the charging voltage V from the power output OUT and then generates the first voltage V₁ coupled to the inverting input of the first OPA 122.

The non-inverting input of the first OPA 122 is electrically connected to a second node with second voltage V₂. More particularly, the non-inverting input of the first OPA 122 is connected to ground via a third voltage-dividing resistor 148 and a fourth voltage-dividing resistor 150 electrically connected in series, and is further electrically connected to the power output OUT via a fifth voltage-dividing resistor 151; the third voltage-dividing resistor 148, the fourth voltage-dividing resistor 150, and the fifth voltage-dividing resistor 151 collectively constitute another voltage-dividing circuit; the voltage-dividing circuit constituted by the third voltage-dividing resistor 148, the fourth voltage-dividing resistor 150, and the fifth voltage-dividing resistor 151 receives the charging voltage V from the power output OUT and generates the second voltage V₂ coupled to the non-inverting input of the first OPA 122.

The charge-controlling module 12 further includes a first diode 152 and a current-limiting resistor 156. The anode of the first diode 152 is connected to the cathode of the light emitter 106, and the cathode thereof is connected to the output of the first OPA 122 via the current-limiting resistor 156. The first diode 152 conducts when a low level signal is sent from the output of the first OPA 122; on the contrary, the first diode 152 is cut off when a high level signal is sent from the output of the first OPA 122. The current-limiting resistor 156 is used for limiting the current flows through the first diode 152.

The second OPA 124 includes an inverting input, a non-inverting input, and an output; the inverting input of the second OPA 124 is electrically connected to the sense resistor 120 and the negative terminal of the battery BAT for receiving the sensing voltage via a bias resistor 134. The non-inverting input of the second OPA 124 is not only connected to the fifth voltage-dividing resistor 151 via a sixth voltage-dividing resistor 160, but also connected to ground via a seventh voltage-dividing resistor 162; the fifth voltage-dividing resistor 151, the sixth voltage-dividing resistor 160, and the seventh voltage-dividing resistor 162 collectively constitute a voltage-dividing circuit, and the voltage-dividing circuit constituted by the fifth voltage-dividing resistor 151, the sixth voltage-dividing resistor 160, and the seventh voltage-dividing resistor 162 receives the charging voltage V from the power output OUT and then generates a voltage coupled to the non-inverting input of the second OPA 124. A high level signal is sent from the output of the second OPA 124 when the voltage coupled to the non-inverting input of the second OPA 124 is greater than that coupled to the inverting input of the second OPA 124; conversely, a low level signal is sent from the output of the second OPA 124 when the voltage coupled to the non-inverting input is lower than or equal to that coupled to the inverting input of the second OPA 124. The charge-controlling module 12 may further includes capacitors 163, 164, and 165; the capacitor 163 is placed between the power output OUT and ground and electrically connected thereto for maintaining the voltage supplying to the controlling unit 121; the capacitor 164 is placed between the inverting input of the second OPA 124 and ground and electrically connected thereto, and the capacitor 165 is placed between the inverting input and the output of the second OPA 124 and electrically connected thereto for achieving the effects of isolation.

The first capacitor 126 is placed between the outputs of the first OPA 122 and the second OPA 124 and electrically connected thereto. The first capacitor 126 is charged when a high level signal is sent from the output of the first OPA 122 and a low level signal is sent from the output of the second OPA 124.

The transistor 128 may be an NMOS transistor; it will be switched off when its enable terminal (i.e., the gate) receives a low level signal and switched on when its enable terminal receives a high level signal. The enable terminal of the transistor 128 is not only electrically connected to the output of the second OPA 124 via the first resistor 136, but also electrically connected to the power output OUT via the second resistor 138. The enable terminal of the transistor 128 is further electrically connected to the anode of the second LED 16 via the third resistor 140; the cathode of the second LED 16 and the source of the transistor 128 are directly connected to ground. The drain of the transistor 128 is not only electrically connected to the power output OUT via the fourth resistor 142, but also electrically connected to the anode of the first LED 14; the cathode of the first LED 14 is directly connected to ground. Herein, the first resistor 136, the second resistor 138, the third resistor 140, and the fourth resistor 142 provide a means of current-limitation for protecting the transistor 128, the first LED 14, and the second LED 16.

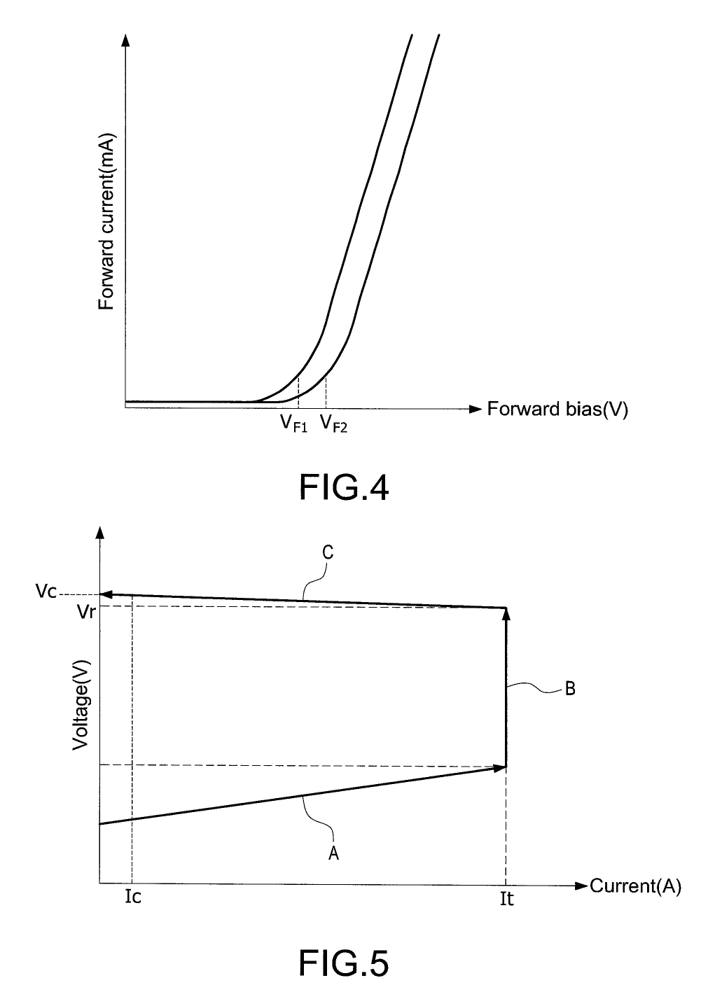

The first LED 14 illuminates red light and the second LED 16 illuminates green light under sufficient forward bias; in the present disclosure, the first LED 14 illuminates red light to indicate the battery BAT dose not reach a fully charged state as yet (i.e., the battery BAT is in a charging state), and the second LED 16 illuminates green light to indicate the battery BAT is about to be fully charged. Due to the first LED 14 and the second LED 16 are designed to illuminate different colors of light for indicating that the battery BAT is fully charged or not, they may be made of different semiconductor materials, and the turn-on voltage V_{F1} of the first LED 14 may be smaller than the turn-on voltage V_{F2} of the second LED 16, as shown in FIG. 4.

The charging system 1 may further include a comparator 144, a second diode 154, and a current-limiting resistor 158. The comparator 144 includes an inverting input, a non-inverting input, and an output; the inverting input of the comparator 144 is electrically connected to the sense resistor 120 and the negative terminal of the battery BAT via the bias resistor 134 for receiving the sensing voltage, and the non-inverting input thereof is electrically connected to a compared voltage V_{COMP}. The voltage-dividing circuit constituted by the third voltage-dividing resistor 148, the fourth voltage-dividing resistor 150, and the fifth voltage-dividing resistor 151 receives the charging voltage V from the power output OUT of the power converter 100 and then generates the compared voltage V_{COMP} coupled to the non-inverting input of the comparator 144. The comparator 144 sends a high level signal from its output when the voltage coupled to the inverting input is lower than or equal to the compared voltage V_{COMP}; on the other hand, the comparator 144 sends a low level signal from its output when the voltage coupled to the inverting input is greater than the compared voltage V_{COMP}. The charge-controlling module 12 may further includes capacitors 168 and 170; the capacitor 168 is placed between the inverting input and the non-inverting input of the comparator 144 and electrically connected thereto, and the capacitor 170 is placed between the non-inverting input of the comparator 144 and ground.

The anode of the second diode 154 is connected to the cathode of the light emitter 106, and the cathode of the second diode 154 is connected to the output of the comparator 144 via the current-limiting resistor 158. The second diode 154 conducts when the low level signal is sent from the output of the comparator 144; on the contrary, the second diode 154 is cut off when the high level signal is sent from the output of the comparator 144. The current-limiting resistor 158 is used for limiting the current flows through the second diode 158.

The charging system 1 may still further includes a second capacitor 166 placed between the output of the comparator 144 and the inverting input of the first OPA 122 and electrically connected thereto; the second capacitor 166 is configured to absorb noises existed in the output of the comparator 144 and the inverting input of the first OPA 122, therefore the voltage therebetween can be stabilized.

Please refer to FIG. 1 and FIG. 3 again; the charge system 1 of the present disclosure may perform a charging operation for charging the battery BAT. During the charging operation is performed, the charging process may be divided into three phases, including a trickle charge phase, a constant current (CC) charge phase and a constant voltage (CV) charge phase. When the charging system 1 is operated in the trickle charge phase to charge the battery BAT at a low current (as the line segment A shown in FIG. 5), the voltage of the battery BAT is gradually increased. During the trickle charge phase, the first voltage V₁ coupled to the inverting input of the first OPA 122 is lower than the second voltage V₂ coupled to non-inverting input thereof, the output of the first OPA 122 outputs the high level signal accordingly; in consequence, the first diode 152 is cut off.

Meanwhile, the output of the second OPA 124 outputs the low level signal since the voltage coupled to its non-inverting input is lower than that coupled to the inverting input thereof; hence the first LED 14 illuminates red light and the first capacitor 126 is charged. Additionally, the voltage coupled to the inverting input of the comparator 144 is lower than that coupled to the non-inverting input thereof (i.e., the compared voltage V_{COMP}), thus the high level signal is sent from the output of the comparator 144; the second diode 154 is cut off accordingly. The light emitter 106 does not generate optical radiation since the first diode 152 and the second diode 154 are cut off, for this reason, the controller 102 generates the PWM signal with particular duty cycle to the power converter 100 to increase the charging voltage V and charging current I.

After the charging current I is increased to a predetermined current It, the voltage coupled to the inverting input of the comparator 144 is greater than that coupled to the non-inverting input thereof (i.e., the compared voltage V_{COMP}), hence the low level signal is sent from the output of the comparator 144. The second diode 154 conducts and the light emitter 106 generates optical radiation accordingly. The light receiver 108 converts the optical radiation to an electrical signal and transmits the electrical signal to the controller 102 thereafter. The controller 102 then generates the PWM signal with another duty cycle to the power converter 100 for fixing the charging current I for charging the battery BAT (as the line segment B shown in FIG. 5). During the constant current charge phase, the charging system 1 charges the battery BAT at the predetermined current It, hence electrical energies may be rapidly stored in the battery BAT to make the voltage of the battery BAT gradually increase.

In the present disclosure, the first voltage-dividing resistor 130, the second voltage-dividing resistor 132, the third voltage-dividing resistor 148, the fourth voltage-dividing resistor 150, and the fifth voltage-dividing resistor 151 can have resistances suitable for making the second voltage V₂ equal to a breakdown voltage of the Zener diode 125 when the voltage of the battery BAT is equal to a regulation voltage Vr. Accordingly, when the voltage of the battery BAT is greater than the regulation voltage Vr, the second voltage V₂ is regulated down to a stable Zener breakdown voltage. Moreover, the output of the first OPA 122 is of a high-to-low transition when the first voltage V₁ coupled the inverting input of the first OPA 122 is greater than the second voltage V₂ coupled to the non-inverting input the first OPA 122; the first diode 152 conducts accordingly. Meanwhile, the second diode 154 is cut off when the high level signal is outputted from the output of the comparator 144.

As mentioned previously, the voltage-dividing circuit constituted by the first voltage-dividing resistor 130 and the second voltage-dividing resistor 132 will receive the charging voltage V from the power output OUT and generate the first voltage V₁ coupled to the inverting input of the first OPA 122; however, the first voltage V1 for supplying to the inverting input of the first OPA 122 may become unstable due to power noise from the power conversion module 10; this phenomenon results in the signal outputted from the first OPA 122 having no transition when the voltage of the battery BAT has reached the regulation voltage Vr. The second capacitor 166 place between the output of the capacitor 144 and the inverting input of the first OPA 122 and electrically connected thereto will absorb the power noise from the power conversion module 10, hence the signal outputted from the first OPA 122 is capable of having the transition when the voltage of the battery BAT has reached the regulation voltage Vr. In addition, the second capacitor 166 may further absorb the transition noise from the output of the comparator 144 when the output of the comparator 144 is of a low-to-high transition, so as to prevent the second diode 154 from constantly turning on and off; thereby the power conversion module 10 is capable of stably supplying power.

When the first diode 152 conducts and the second diode 154 is cut off, the light emitter 106 generates optical radiation. In the present disclosure, the low level signal sent from the output of the first OPA 122 may be different from that sent from the output of the comparator 144, thus intensity of the optical radiation generated from the light emitter 106 while the low level signal is sent from the output of the first OPA 122 may be different from that while the low level signal is sent from the output of the comparator 144. Herein the signal sent from the output of the first OPA 122 is a stable voltage signal, hence the current flowing through the light emitter 106 is a constant current, which makes the light emitter 106 generate optical radiation that results in a unique intensity; the electrical signal converted from the optical radiation by the light receiver 108 is a non-variable signal to make the controller 102 generate PWM signal with fixed duty cycle to drive the power conversion module 10 to generate a constant voltage for charging the battery BAT.

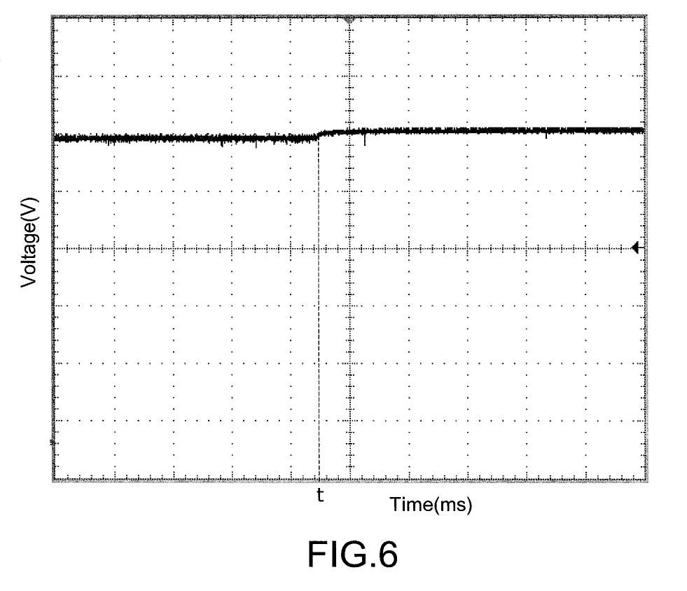

When the charging system 1 is operated in the constant voltage charge phase (as the line segment C shown in FIG. 5), the voltage of the battery BAT is slightly increased; however, the charging current I is gradually decreased. In the present disclosure, the sixth voltage-dividing resistor 160 and the seventh voltage-dividing resistor 162 can have resistances suitable for making the charging current I be smeller that critical current Ic when the voltage of the battery BAT is greater than a critical voltage Vc; as a result, the voltage coupled to the non-inverting input of the second OPA 124 may be greater than that coupled to the inverting input thereof, and the output of the second OPA 124 sends the high level signal to drive the transistor 128 to be switched on. Meanwhile, the second LED 16 illuminates green light. When the high level signal is sent from the output of the second OPA 124, the voltage charged within the first capacitor 126 is applied to the output of the first OPA 122 for increasing the level of the signal output from the first OPA 122 (as point t shown in FIG. 6), hence the current flowing through the light emitter 106 decreases and the intensity of the optical radiation is reduced. Thereby the electrical signal converted from the optical radiation by the light receiver 108 is varied to make the controller 102 generate PWM signal with different duty cycle to drive the power conversion module 10 to lower the charging voltage V and the charging current I. The charging current I is decreased to 0 when the battery BAT is fully charged.

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within the scope of the disclosure as defined in the appended claims.

What is claimed is:

1. A charging system configured to charge a battery, the charging system comprising:
a first light emitting diode (LED);
a second LED;
a power conversion module electrically connected to the first LED and the second LED; and
a charge-controlling module comprising:
a controlling unit;
a comparator electrically connected to the power conversion module; and
a transistor electrically connected to the controlling unit, the first LED, and the second LED;
wherein when a voltage of the battery is lower than or equal to a critical voltage, the controlling unit outputs a low level signal to the transistor to illuminate the first LED and turn the second LED off, and when the voltage of the battery is greater than the critical voltage, the controlling unit outputs a high level signal to the transistor to turn the first LED off and illuminate the second LED; and
when the voltage of the battery is lower than or equal to a regulation voltage, the comparator outputs a first signal to drive the power conversion module to charge the battery with a constant current, and when the voltage of the battery is greater than the regulation voltage, the controlling unit provides a second signal to drive the power conversion module to charge the battery with a constant voltage, the regulation voltage is smaller than the critical voltage.

2. The charging system of claim 1, wherein the controlling unit comprises:
a first operational amplifier (OPA) comprising two inputs and an output, wherein one of the inputs is electrically connected to a first node for receiving a first voltage, the other input is electrically connected to a second node for receiving a second voltage, and the output is connected to the power conversion module; and
a Zener diode electrically connected to the second node;
wherein the Zener diode provides voltage stabilizing function when the voltage of the battery is greater than the regulation voltage, and the first OPA generates the second signal when the voltage of the battery is greater than regulation voltage for driving the power conversion module to charge the battery with the constant voltage.

3. The charging system of claim 2, wherein the charge-controlling module further comprises a first diode arranged between the power conversion module and the output of the first OPA and electrically connected to the power conversion module and the output the first OPA, the first diode conducts when the second signal is sent from the output of the first OPA.

4. The charging system of claim 2, wherein the charge-controlling module further comprises:
a first voltage-dividing resistor arranged between the power conversion module and the first OPA and electrically connected to the power conversion module and the first OPA; and
a second voltage-dividing resistor electrically connected to the first voltage-dividing resistor in series, the first voltage-dividing resistor and the second voltage-dividing resistor receive a charging voltage provided by the power conversion module and then generate the first voltage.

5. The charging system of claim 2, wherein the charge-controlling module further comprises a sense resistor electrically connected to the battery and used for sensing a current flowing through the battery indicating the voltage of the battery; and
wherein the controlling unit further comprises a second OPA comprising two inputs and an output, one of the inputs is electrically connected to the power conversion module, the other input is electrically connected to the sense resistor, and the output is connected to the transistor, the second OPA outputs the low level signal when the voltage of the battery is lower than or equal to the critical voltage to illuminate the first LED, and the second OPA outputs the high level signal when the voltage of the battery is greater than the critical voltage to illuminate the second LED.

6. The charging system of claim 5, wherein the charge-controlling module further comprises a first capacitor placed between the outputs of the first OPA and second OPA and electrically connected to the outputs of the first OPA and the second OPA, the first capacitor is charged when the voltage of the battery is lower than or equal to the critical voltage; when the voltage of the battery is greater than the critical voltage, the voltage charged in the first capacitor is applied to the output of the first OPA for increasing the level of signal sent from the output of the first OPA.

7. The charging system of claim 5, wherein the charge-controlling module further comprises:
a third voltage-dividing resistor;
a fourth voltage-dividing resistor electrically connected to the third voltage-dividing resistor in series; and
a fifth voltage-dividing resistor arranged between the third voltage-dividing resistor and the power conversion module and electrically connected to the third voltage-dividing resistor and the power conversion module, the third voltage-dividing resistor, the fourth voltage-dividing resistor, and the fifth voltage-dividing resistor receive the charging voltage provided by the power conversion module and then generate the second voltage and a compared voltage, wherein the compared voltage is applied to an input of the comparator, and the other input of the comparator is electrically connected to the sense resistor.

8. The charging system of claim 2, further comprising:
a second diode arranged between the power conversion module and an output of the comparator and electrically connected to the power conversion module and the output of the comparator, wherein the second diode conducts when the first signal is sent from the output of the comparator, and the power conversion module is driven to charge the battery with the constant current.

9. The charging system of claim 2, wherein the charge-controlling module further comprises a second capacitor arranged between an output of the comparator and the input of the first OPA where the first node is connected and electrically connected to the output of the comparator and the input of the first OPA where the first node is connected and the second capacitor is used for absorbing transition noise of the comparator and power noise.

10. The charging system of claim 1, wherein the transistor is an NMOS transistor.
